(19) United States
(12) Patent Application Publication
(10) Pub. No.: US 2025/0092897 A1
(43) Pub. Date: Mar. 20, 2025

(54) Sealed Fastener Assembly

(71) Applicant: Illinois Tool Works Inc., Glenview, IL (US)

(72) Inventor: Mark A. Beyer, Armada, MI (US)

(21) Appl. No.: 18/823,955

(22) Filed: Sep. 4, 2024

Related U.S. Application Data
(60) Provisional application No. 63/538,878, filed on Sep. 18, 2023.
(60) Provisional application No. 63/636,182, filed on Apr. 19, 2024.
(60) Provisional application No. 63/644,822, filed on May 9, 2024.

(51) Int. Cl. F16B 5/02

(52) U.S. Cl. CPC F16B 5/0258; F16B 5/0241

(57) ABSTRACT

Described is a sealed fastener assembly for attaching a first component to a second component via a male fastener having a head and a shank. The sealed fastener assembly includes a seal and a retainer clip. The seal has a generally planar surface and a seal opening. The retainer clip has a body portion comprising a first plate that is resiliently connected to a second plate via a clip sidewall to define a channel. The second plate comprises a recessed seal pocket configured to receive at least a portion of the seal. The retainer clip is configured to receive at least a portion of the first component via the channel.

### RELATED APPLICATIONS

The present application claims priority to U.S. Provisional Patent Application No. 63/538,878, filed Sep. 18, 2023, to U.S. Provisional Patent Application No. 63/636,182, filed Apr. 19, 2024, and to U.S. Provisional Patent Application No. 63/644,822, filed May 9, 2024, all entitled “Sealed Fastener for Spoiler Attachment,” which are hereby incorporated by reference.

### BACKGROUND

Automotive components require fastening techniques that are simple to manufacture and assemble. Further, fastening techniques should above all be reliable and efficient. In some examples, it's beneficial to limit the amount of compression imparted on a component.

In some cases, compression limiters can be used when an application includes a more delicate material that has a compressive load to bear, such as plastic. The compression limiter strengthens the assembly and accepts the load that is applied when a fastener is tightened within the assembly. When a compression limiter is used, the material's integrity is not compromised by the added pressure. In many fastening systems, it is crucial to maintain a tight seal between components to prevent leakage, contamination, or loosening of the fastener.

Existing solutions are overly complex, which increases the cost, number of components needed, and assembly complexity and time. Therefore, despite advancements to date, it would be highly desirable to have a compression limiting fastener with improved characteristics that is configured to limit the amount of compression on one or more components, such as vehicle components. The disclosed fastening system introduces a seal that not only ensures a secure fit but also enhances the sealing properties when the fastener is assembled.

### SUMMARY

The present disclosure relates generally to a fastening system to form a connection between two components, such as vehicular components, using a sealed fastener assembly, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a side elevational assembly view of the fastening system in accordance with a first aspect of this disclosure.

FIG. 1b illustrates an isometric assembly view of the fastening system of FIG. 1a, with the first and second components omitted for illustrative purposes, while FIG. 1c illustrates an isometric assembled view thereof.

FIG. 1d illustrates a cross-sectional elevation side view of the fastening system of FIG. 1a, taken along cutline A-A (FIG. 1c).

FIG. 1e illustrates an isometric assembly view of the sealed fastener assembly.

FIG. 1f illustrates a side elevational assembly view of the sealed fastener assembly.

FIG. 1g illustrates a topside assembled view of the sealed fastener assembly.

FIG. 1h illustrates an underside assembled view of the sealed fastener assembly.

FIG. 2a illustrates a side elevational assembly view of the fastening system in accordance with a second aspect of this disclosure.

FIG. 2b illustrates an isometric assembly view of the fastening system of FIG. 2a, with the first and second components omitted for illustrative purposes, while FIG. 2c illustrates an isometric assembled view thereof.

FIG. 2d illustrates a cross-sectional elevation side view of the fastening system of FIG. 2a, taken along cutline B-B (FIG. 2c).

FIG. 2e illustrates an isometric assembly view of the sealed fastener assembly.

FIG. 2f illustrates a side elevational assembly view of the sealed fastener assembly.

FIG. 2g illustrates a topside assembled view of the sealed fastener assembly.

FIG. 2h illustrates an underside assembled view of the sealed fastener assembly.

FIG. 3a illustrates a side elevational assembly view of the fastening system in accordance with a third aspect of this disclosure.

FIG. 3b illustrates an isometric assembly view of the fastening system of FIG. 3a, with the first and second components omitted for illustrative purposes, while FIG. 3c illustrates an isometric assembled view thereof.

FIG. 3d illustrates a cross-sectional elevation side view of the fastening system of FIG. 3a, taken along cutline C-C (FIG. 3c).

FIG. 3e illustrates an isometric assembly view of the sealed fastener assembly.

FIG. 3f illustrates a side elevational assembly view of the sealed fastener assembly.

FIG. 3g illustrates a topside assembled view of the sealed fastener assembly.

FIG. 3h illustrates an underside assembled view of the sealed fastener assembly.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Traditional nut solutions often involve separate cold-headed parts assembled with a secondary seal, while stud solutions use profiles for both compression limiting and sealing. However, these designs face challenges in tight packaging conditions, particularly when customers require direct contact between components. The subject disclosure presents novel solutions that address these limitations.

Disclosed is a sealed fastener assembly for attaching a first component to a second component via a male fastener. The sealed fastener assembly being configured to form a seal and/or to limit compression on the first component and/or the second component, thus serving to prevent deformation of plastic substrates and fluid intrusion. The nut solution features flexible spring flanges that retain the clip in the mating panel, allowing for easy insertion. The design also provides compression limiting to prevent substrate deformation and incorporates a recessed, circular feature for applying a sealing membrane. Additionally, the fastener assembly offers flexibility in placing the seal either on the nut or under the bolt head, enhancing water resistance.

In some examples, the retained stud solution introduces a short-drawn sleeve with retainers (e.g., indentations) to secure the bolt during handling, along with a sealing membrane to prevent water intrusion. Flanges can be employed to prevent bolt rotation during nut installation, while anti-rotation features can be facilitated via recessed cavities, allowing for tighter packaging.

Advantages of the present disclosure include weight savings by replacing cold-headed parts with lighter spring steel, improved sealing performance through a more robustly applied membrane, enhanced packaging conditions, and flexibility in accommodating different stud sizes. Additionally, these solutions ensure more secure retention of seals to metal components during shipping and handling, offering a more cost-effective and reliable alternative to existing market solutions.

In one example, a sealed fastener assembly for attaching a first component to a second component via a male fastener having a head and a shank comprises: a seal having a generally planar surface and a seal opening; and a retainer clip having a body portion comprising a first plate that is resiliently connected to a second plate via a clip sidewall to define a channel, wherein the second plate comprises a recessed seal pocket configured to receive at least a portion of the seal, and wherein the retainer clip is configured to receive at least a portion of the first component via the channel.

In another example, a retainer clip for attaching a first component to a second component via a male fastener having a head and a shank comprises: a first plate having a recessed fastener pocket with a first opening formed therein, wherein the recessed fastener pocket is configured to receive the head of the male fastener and to mitigate rotation of the head; and a second plate having a recessed seal pocket with a second opening formed therein, wherein the second plate is resiliently connected to the first plate via a clip sidewall to define a channel, wherein the recessed seal pocket is configured to receive at least a portion of a seal, wherein the retainer clip is configured to receive at least a portion of the first component via the channel, and wherein the recessed fastener pocket and the recessed seal pocket are configured to interact with each other to maintain a distance between the first plate and the second plate.

In yet another example, a retainer clip for attaching a first component to a second component via a male fastener having a head and a shank comprises: a first plate having a collar with an internally-threaded bore configured to threadedly engage the shank; and a second plate having a recessed seal pocket with a second opening formed therein, wherein the second plate is resiliently connected to the first plate via a clip sidewall to define a channel, wherein the recessed seal pocket is configured to receive at least a portion of a seal, wherein the retainer clip is configured to receive at least a portion of the first component via the channel. The collar can be configured to maintain a distance between the first plate and the second plate.

In some examples, the first plate comprises a recessed fastener pocket with a first opening formed therein.

In some examples, the recessed fastener pocket is configured to receive the head of the male fastener and to mitigate rotation of the head.

In some examples, the recessed seal pocket defines a second opening that aligns with the first opening to define a fastener hole configured to receive at least a portion of the shank.

In some examples, the recessed fastener pocket and the recessed seal pocket are configured to interact with each other to maintain a distance between the first plate and the second plate.

In some examples, the recessed seal pocket is configured to extend from the second plate toward the first plate.

In some examples, the recessed seal pocket defines a circular perimeter.

In some examples, the generally planar surface of the seal comprises one or more annular rings are configured to compress or deform during assembly.

In some examples, the seal opening is concentric with the one or more annular rings.

In some examples, the seal defines a second generally planar surface that is opposed to the generally planar surface.

In some examples, the second generally planar surface comprises one or more annular rings.

In some examples, the seal defines an annular portion that defines the generally planar surface and a collar portion that extends perpendicularly from the annular portion.

In some examples, the first plate defines a set of planar wings that is generally parallel to the first plate and offset relative to the first plate by a distance.

In some examples, the first plate comprises a collar having an internally-threaded bore configured to threadedly engage the shank.

In some examples, the retainer clip is a stamped-metal component.

In some examples, at least one of the first plate or the second plate defines one or more retainer tabs configured to retain the male fastener as a part-in-assembly (PIA).

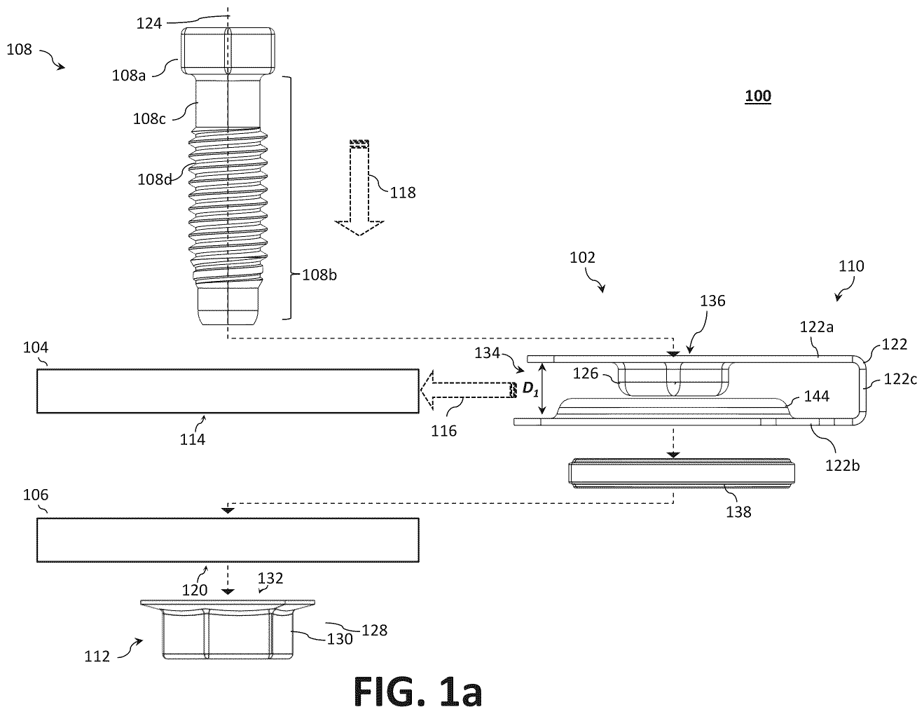

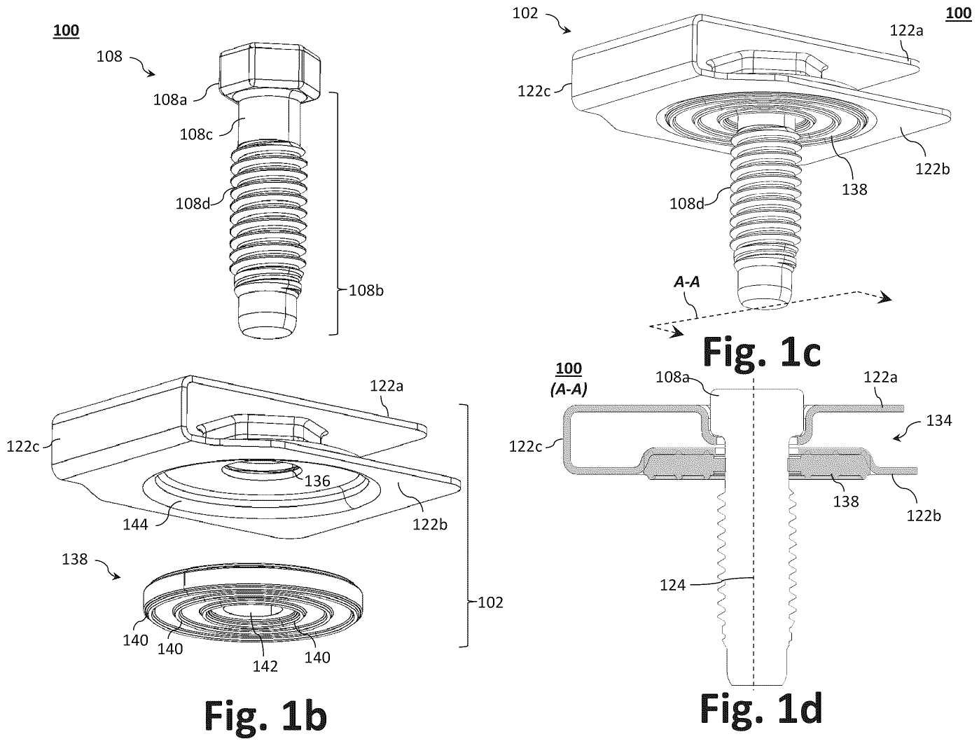

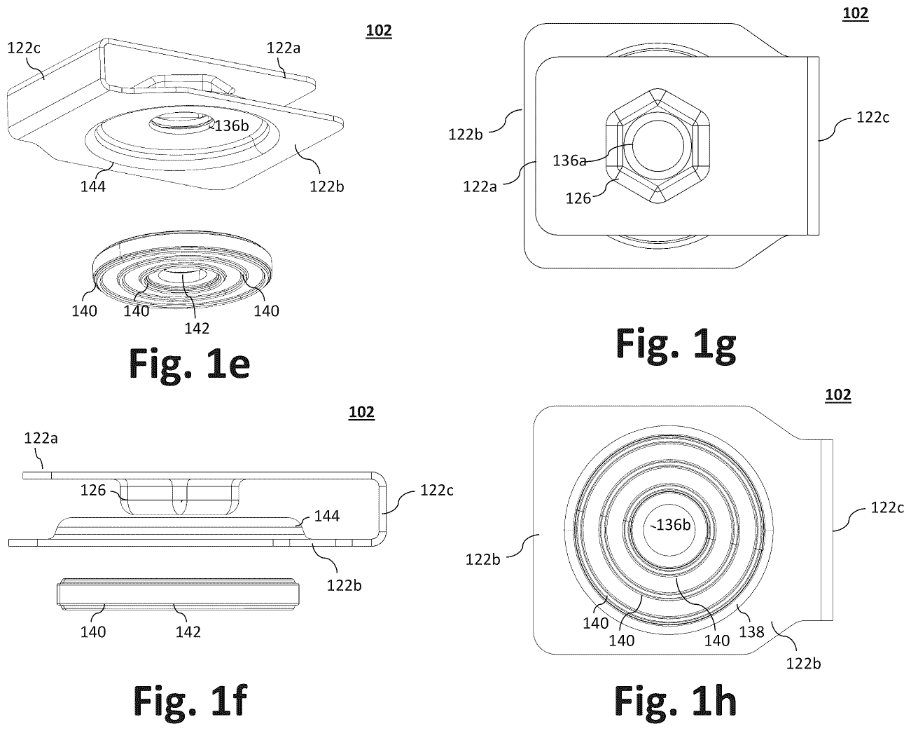

FIG. 1a illustrates a side elevational assembly view of the fastening system 100 in accordance with a first aspect of this disclosure. FIG. 1b illustrates an isometric assembly view of the fastening system 100 of FIG. 1a, with the first component 104 and second component 106 omitted for illustrative purposes, while FIG. 1c illustrates an isometric assembled view thereof. FIG. 1d illustrates a cross-sectional elevation side view of the fastening system 100 of FIG. 1a, taken along cutline A-A (FIG. 1c). FIG. 1e illustrates an isometric assembly view of the sealed fastener assembly 102. FIG. 1f illustrates a side elevational assembly view of the sealed fastener assembly 102. FIG. 1g illustrates a topside assembled view of the sealed fastener assembly 102. FIG. 1h illustrates an underside assembled view of the sealed fastener assembly 102. Although the figures depict a single retainer 110 and fastener 108, a plurality of retainers 110 and fasteners 108 may be used to secure a single first component 104 to a single second component 106. For example, four fasteners 108 may be used at spaced-apart locations along a portion of the first component 104 and second component 106. It is contemplated that the fasteners 108 may be disposed symmetrically (e.g., at each corner of the first component 104) or in an asymmetrical or staggered configuration.

The illustrated fastening system 100 includes the first component 104, the second component 106, and a sealed fastener assembly 102. The sealed fastener assembly 102 is configured to join the first component 104 and the second component 106 while limiting compression on the first component 104 and/or the second component 106. In this example, the sealed fastener assembly 102 is a multi-component assembly composed of a retainer 110 and a seal 138.

To facilitate attachment via the sealed fastener assembly 102, each of the first component 104 and the second component 106 can include one or more engagement features. For example, the first component 104 is illustrated as having a first opening 114 formed therein, and the second component 106 is illustrated as having a second opening 120 formed therein. The first opening 114 and the second opening 120 can be formed in the respective first component 104 or second component 106 during manufacturing or added post-manufacture through a mechanical process (e.g., drilling, cutting, carving, etc.). After the first component 104 and the second component 106 are assembled, the second component 106 is at least partially covered by the first component 104.

In the example of FIGS. 1a through 1h, the sealed fastener assembly 102 is configured to engage a male fastener 108 (e.g., an externally threaded shaft, such as a bolt) via a female fastener 112 (e.g., an internally threaded component, such as a nut or threaded collar). As illustrated, the male fastener 108 comprises a head 108a and a shank 108b. In the illustrated example, the head 108a is hex-shaped, and the shank 108b defines a threaded portion 108d and an unthreaded portion 108c adjacent to the head 108a (e.g., the grip). In this example, the retainer 110 serves to mechanically engage and couple with the first component 104 via the first opening 114, while the male fastener 108 and the female fastener 112 serve to couple the first component (via the retainer 110) to the second component 106 (via its second opening 120). As illustrated, the retainer 110 prevents and/or mitigates compression of the first component 104 via a recessed fastener pocket 126 formed in the retainer 110. As will be discussed, while the example of FIGS. 1a through 1h describes a sealed fastener assembly 102 configured to engage a first opening 114 in the first component 104 via a retainer 110, other configurations are contemplated, such as using a doghouse structure on one of the first component 104 or the second component 106.

It is contemplated that certain components of the multi-component sealed fastener assembly 102 may be fabricated as stamped-metal components using a metal-stamping technique. For example, the retainer 110 can be fabricated from a single sheet of metal and stamped/bent using a metal-stamping technique, while the male fastener 108 and the female fastener 112 can be fabricated from metal via one or more metal-shaping techniques, such as cold forging. In another example, the retainer 110 can be fabricated as a stamped-metal component, whereas the male fastener 108 and the female fastener 112 can be fabricated from a plastic material using a plastic injection technique, additive manufacturing, or otherwise. In some examples, one or more components of the sealed fastener assembly 102 may be fabricated using material extrusion (e.g., fused deposition modeling (FDM), stereolithography (SLA), selective laser sintering (SLS), material jetting, binder jetting, powder bed fusion, directed energy deposition, VAT photopolymerization, or any other suitable type of additive manufacturing/3D printing process).

The first component 104 and the second component 106 may be automotive panels or other automotive parts. Depending on the application, either or both components may be made from materials such as metal (or metal alloys), synthetic or semi-synthetic polymers (e.g., plastics like acrylonitrile butadiene styrene (ABS) and polyvinyl chloride (PVC)), composite materials (e.g., fiberglass), or a combination thereof. In the automotive industry, these components can include, but are not limited to, spoilers, door trim panels, moldings, trim pieces, interior or exterior surfaces, structural parts (e.g., doors, pillars like A-pillars, B-pillars, C-pillars), dashboard components (e.g., cross members, brackets, frames), seat frames, center consoles, fenders, and sheet metal frameworks. The specific material used will vary based on the application and could involve metal, synthetic or semi-synthetic polymers, composite materials, or combinations of these materials. During installation, as best illustrated in FIG. 1a, the retainer 110 is slid into the first opening 114 of the first component 104 as indicated by arrow 116. The first opening 114 is sized and shaped to receive and retain the retainer 110. In the illustrated example, a portion of the first component 104 is sandwiched between the plates of the retainer 110 (e.g., along at least a portion of its perimeter) such that a fastener hole formed in the retainer 110 aligns with a second opening 120 formed in the second component 106.

Once the retainer 110 is installed, an end of the male fastener 108 is passed through a fastener hole 136 formed in the retainer 110 and the second opening 120 as indicated by arrow 118 to ultimately engage the female fastener 112. The male fastener 108 and/or the female fastener 112 can be rotated relative to one another about its axis of rotation 124 to join and compress the first component 104 and second component 106 relative to one another. The sealed fastener assembly 102 includes the seal 138 to mitigate dust, dirt, and/or moisture penetration through the second opening 120.

The seal 138 may be embodied as a ring structure with a seal opening 142 at its center. The seal 138 can be fabricated from various materials depending on the application requirements. For example, it can be made from foam material, thermoplastic, and/or rubber for lightweight applications that are durable while preserving flexibility and resilience. When assembled, the seal 138 is configured to receive the male fastener through the seal opening 142. The seal 138 surrounds a portion of the male fastener, such as the unthreaded portion 108c of the shank 108b located adjacent to the fastener's head 108a. This placement positions the seal 138 between the first component 104 and the retainer 110, ensuring a secure and tight seal. The seal 138 includes one or more annular rings 140 formed on a generally planar surface of the seal 138. In the illustrated example, the seal 138 comprises three annular rings 140 protruding from the generally planar surface that are concentric with one another and with the seal opening 142.

The annular rings 140 can be formed on each side of the seal 138 (e.g., on opposing generally planar surface of the seal 138). These annular rings 140 are configured to compress and deform when the sealed fastener assembly is completed, thereby enhancing the sealing performance between the first component 104 and the retainer 110. This design ensures that the seal 138 provides both a mechanical and environmental seal, improving the overall integrity and reliability of the fastening system.

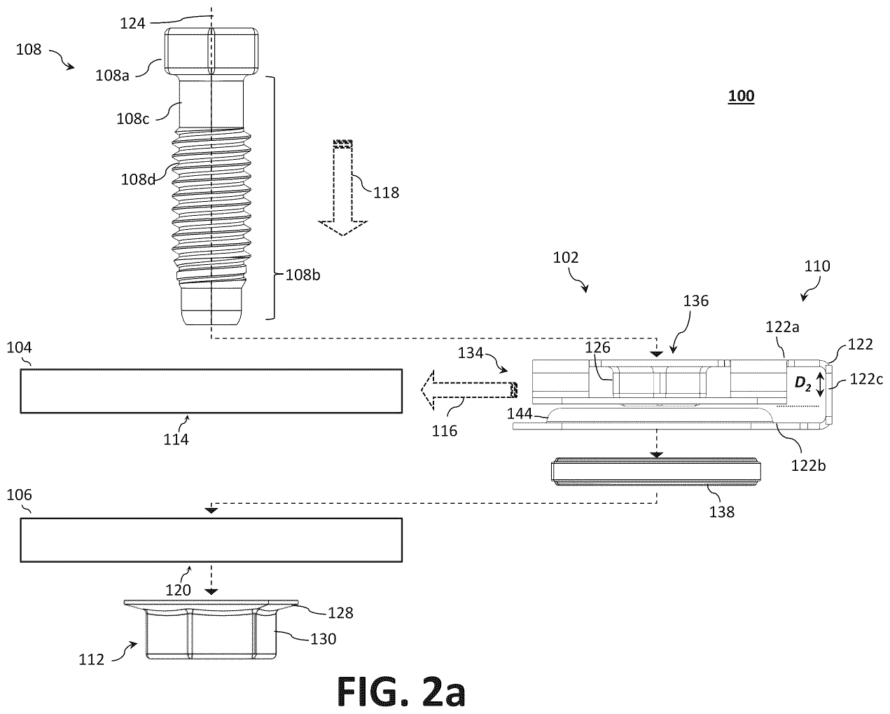

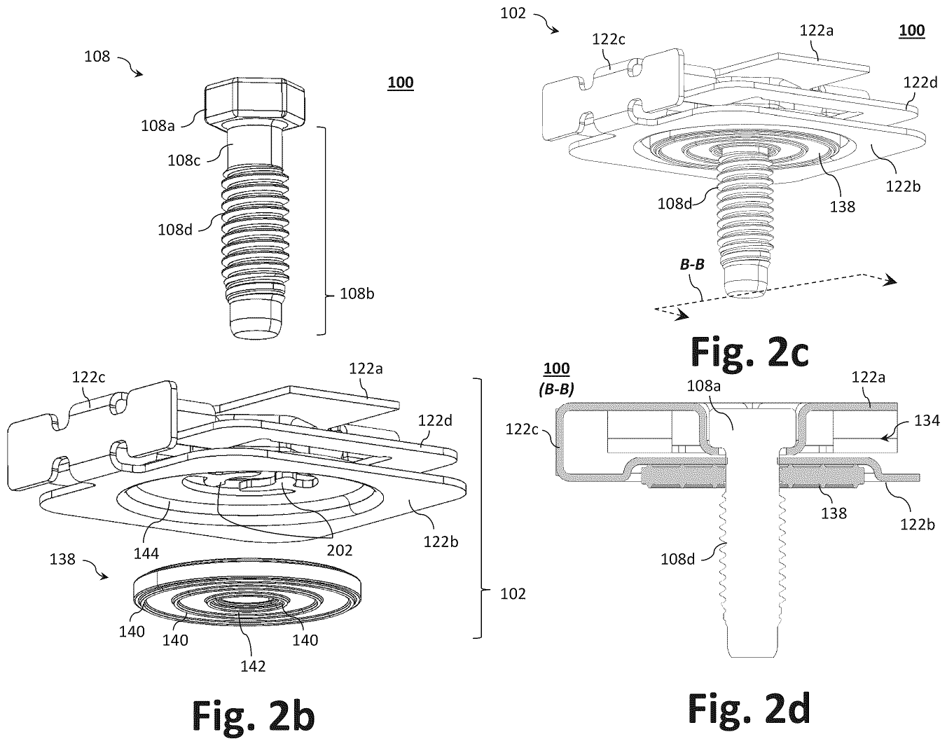

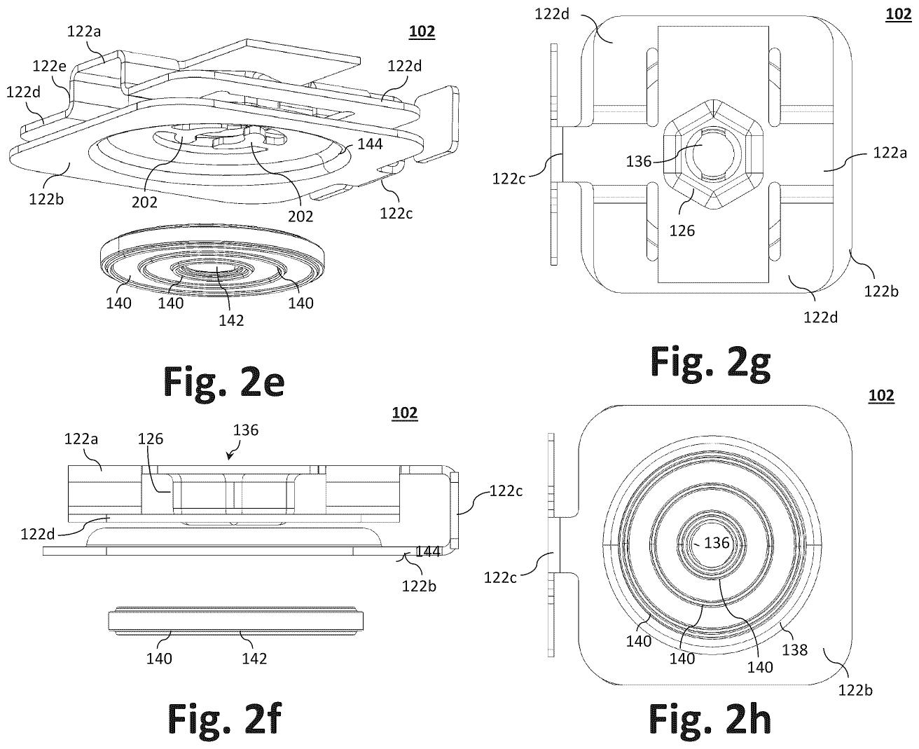

The illustrated retainer 110 comprises a body portion 122 formed with a pair of generally parallel plates, which are illustrated as a first plate 122a and a second plate 122b, resiliently connected to one another via a clip sidewall 122c to form a generally U-shaped body (e.g., a spring clip) having a channel 134 (e.g., a U-shaped channel) therebetween. The first plate 122a and the second plate 122b are resiliently connected such that the pair of opposing first and second plates 122a, 122b default (e.g., spring back) to a predetermined shape. For example, as best illustrated in FIGS. 2b and 2c, the body portion 122 has a side profile that is generally U-shaped. In this example, the channel 134 is sized to slide onto and receive at least a portion of the first component 104 (e.g., the perimeter of the first opening 114). To that end, a first distance (D1) between the pair of opposing first and second plates 122a, 122b generally corresponds to the thickness of the first component 104.

The sealed fastener assembly 102 further includes one or more features to limit the compression imparted on the first component 104 and/or second component 106, thus mitigating the risk of damage to a component when tightening the male fastener 108 and/or the female fastener 112. In this example, the sealed fastener assembly 102 is a single-sided compression limiter, which may be used where only one of the components (e.g., the first component 104) is formed from a material that is prone to damage when compressed (e.g., plastic), while the other component (e.g., the second component 106) may be formed from a material that is less prone to damage (e.g., metal). In this example, the one or more features to limit the compression include a recessed fastener pocket 126 and a recessed seal pocket 144.

The recessed fastener pocket 126 and the recessed seal pocket 144 are configured to slideably engage and receive a portion of the male fastener 108 (e.g., the head 108a and the unthreaded portion 108c of the shank 108b), thus limiting the compression applied by the male fastener 108 and/or the female fastener 112 on the first component 104. For example, when the male fastener 108 is tightened, the unthreaded portion 108c and the head 108a of the male fastener 108 can contact the recessed fastener pocket 126 while the recessed seal pocket 144 prevents compression of the seal 138, which would otherwise compromise its sealing ability.

The illustrated first plate 122a includes or otherwise defines the recessed fastener pocket 126. The recessed fastener pocket 126 is shaped to correspond to the shape of the head 108a. In the illustrated example, the male fastener 108 is a threaded bolt with a hex head 108a, and the recessed fastener pocket 126 has a corresponding hexagonal perimeter. When assembled, the head 108a resides within the recessed fastener pocket 126 and is prevented from rotating about its axis of rotation 124 by the sidewalls of the recessed fastener pocket 126. The illustrated second plate 122b includes or otherwise defines the recessed seal pocket 144. The recessed seal pocket 144 is shaped to correspond to the shape of the seal 138. In the illustrated example, the seal 138 is annular, and the recessed seal pocket 144 has a corresponding circular perimeter. When assembled, the seal 138 resides at least partially within the recessed seal pocket 144. The recessed fastener pocket 126 and the recessed seal pocket 144 each include an opening (e.g., first opening 136a and second opening 136b) that align (at least in part) to collectively define a fastener hole 136 therein (e.g., at the floor or base of each of the recessed fastener pocket 126 and the recessed seal pocket 144). In some examples, the body portion 122 can further comprise retention tabs (e.g., barbs or teeth). For example, the one or more retention tabs can pinch, scrape, dig into, or otherwise grip the first component 104 to prevent the retainer 110 from sliding off. Each retention tab can be stamped and/or punched from the material of the body portion 122 and bent into shape.

As best illustrated in FIG. 1a, the combined depth of the recessed fastener pocket 126 and the recessed seal pocket 144 (e.g., the height of the respective sidewalls) is substantially equal to the first distance (D1) between the pair of opposing first and second plates 122a, 122b, such that an exterior portion of the floor of the recessed fastener pocket 126 and the recessed seal pocket 144 contacts and/or rests on one another upon assembly. The recessed fastener pocket 126 and the recessed seal pocket 144, therefore, serve as a compression limiter for the first component 104. That is, even if the male fastener 108 is overly compressed (e.g., tightened), the recessed fastener pocket 126 and the recessed seal pocket 144 maintain (or otherwise preserve) the first distance (D1) and prevent the pair of opposing first and second plates 122a, 122b from compressing, which could potentially crush the portion of the first component 104 positioned within the channel 134.

In some examples, such as the example shown in FIGS. 2a through 2e, the body portion 122 can further comprise one or more retainer tabs 202 configured to retain the male fastener 108 within the recessed fastener pocket 126 prior to assembly, thus enabling the retainer 110 and male fastener 108 to be packaged as a part-in-assembly (PIA). This configuration reduces the time and effort needed during assembly by an end-user. The recessed fastener pocket 126 can secure the retainer 110 to the first component 104 via interference with the first opening 114.

The female fastener 112 can comprise a head 130, a flange 128, and an internally threaded bore 132 configured to engage the shank 108b. The head 130 can be hex-shaped to facilitate tool engagement, while the flange 128 serves to increase the contact surface area between the head 130 and the second component 106. FIG. 1a illustrates the female fastener 112 in the form of a one-piece flange nut, but the female fastener 112 can be a multi-component piece in other examples.

The sealed fastener assembly 102 can also include noise, vibration, and harshness (NVH) management features, including the seal 138. These features can include various noise-damping, vibration-absorbing, and isolation elements known in the art, such as grommets, washers, gaskets, vibration-damping materials (e.g., viscoelastic or rubber-like materials), coatings (e.g., viscoelastic polymer coatings), adhesives, and dampers. These NVH management features can be incorporated into the sealed fastener assembly to enhance its ability to absorb and reduce noise, vibration, and harshness in the final assembly.

FIG. 2a illustrates a side elevational assembly view of the fastening system 100 in accordance with a second aspect of this disclosure. FIG. 2b illustrates an isometric assembly view of the fastening system 100 of FIG. 2a, with the first component 104 and second component 106 omitted for illustrative purposes, while FIG. 2c illustrates an isometric assembled view thereof. FIG. 2d illustrates a cross-sectional elevation side view of the fastening system 100 of FIG. 2a, taken along cutline B-B (FIG. 2c). FIG. 2e illustrates an isometric assembly view of the sealed fastener assembly 102. FIG. 2f illustrates a side elevational assembly view of the sealed fastener assembly 102. FIG. 2g illustrates a topside assembled view of the sealed fastener assembly 102. FIG. 2h illustrates an underside assembled view of the sealed fastener assembly 102. As with the prior example, during installation, as best illustrated in FIG. 2a, the retainer 110 is slid into the first opening 114 of the first component 104 as indicated by arrow 116.

The sealed fastener assembly 102 depicted in FIGS. 2a through 2h is similar to the assembly shown in FIGS. 1a through 1h, with a few differences. To avoid redundancy, features and components already described with reference to the previous example are not repeated here. Instead, the focus is on the new or modified aspects. As best illustrated in FIG. 2a, the recessed fastener pocket 126 maintains the second distance (D2) between the first component 104 and the recessed seal pocket 144, thus limiting compression imparted on the first component 104. In this example, the second distance (D2) generally corresponds to the thickness of the second component 106.

In this example, as best illustrated in FIG. 2e, the first plate 122a is shaped on two sides (e.g., two opposing sides of the second plate 122b adjacent the clip sidewall 122c) to define a set of planar wings 122d. Each of the planar wings 122d is generally parallel to the first plate 122a and offset relative to the first plate 122a by a distance. In the illustrated example, the first plate 122a is offset relative to the set of planar wings 122d by a wing sidewall 122e. As illustrated, the wing sidewall 122e is generally perpendicular to each of the first plate 122a and planar wings 122d. In the illustrated example, the height of the wing sidewall 122e generally corresponds to the thickness of the second component 106 (or portion thereof, such as a doghouse feature).

The assembly shown in FIGS. 2a through 2h includes a pair of retainer tabs 202 configured to engage the unthreaded portion 108c of the shank 108b. As illustrated in FIGS. 2b and 2e, these retainer tabs 202 extend into an opening formed in the recessed seal pocket 144, aligning with the unthreaded portion 108c of the shank 108b when assembled. Each retainer tab 202 is resiliently coupled with the second plate 122b and is formed in a Y-shape.

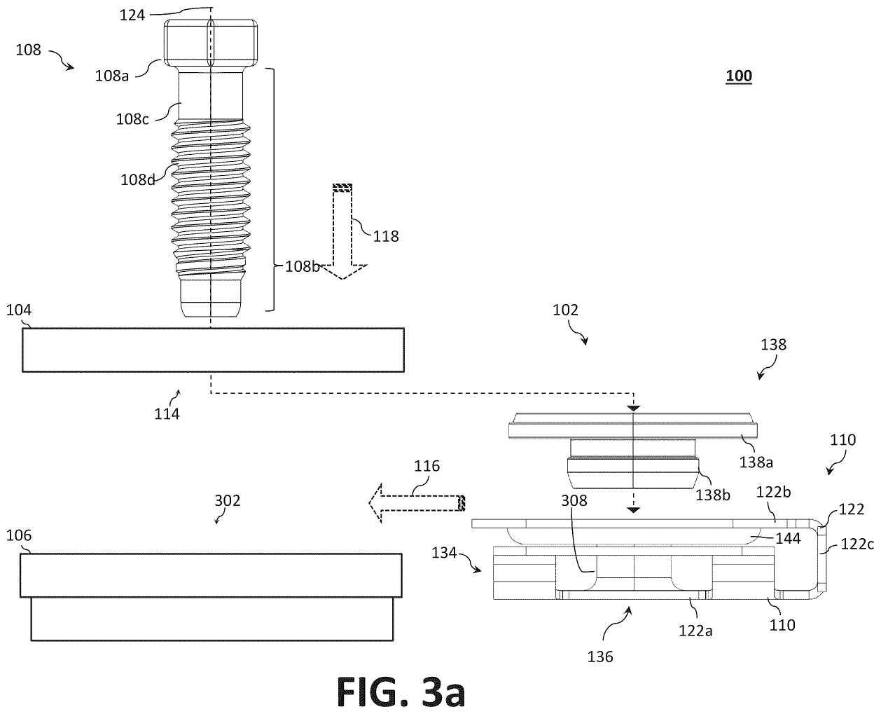

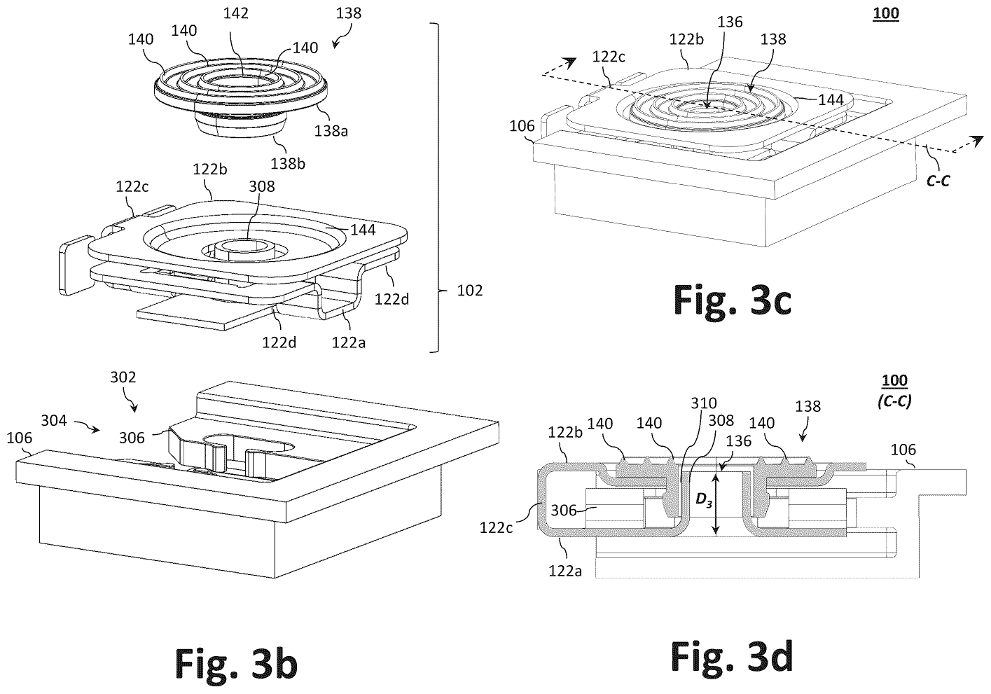

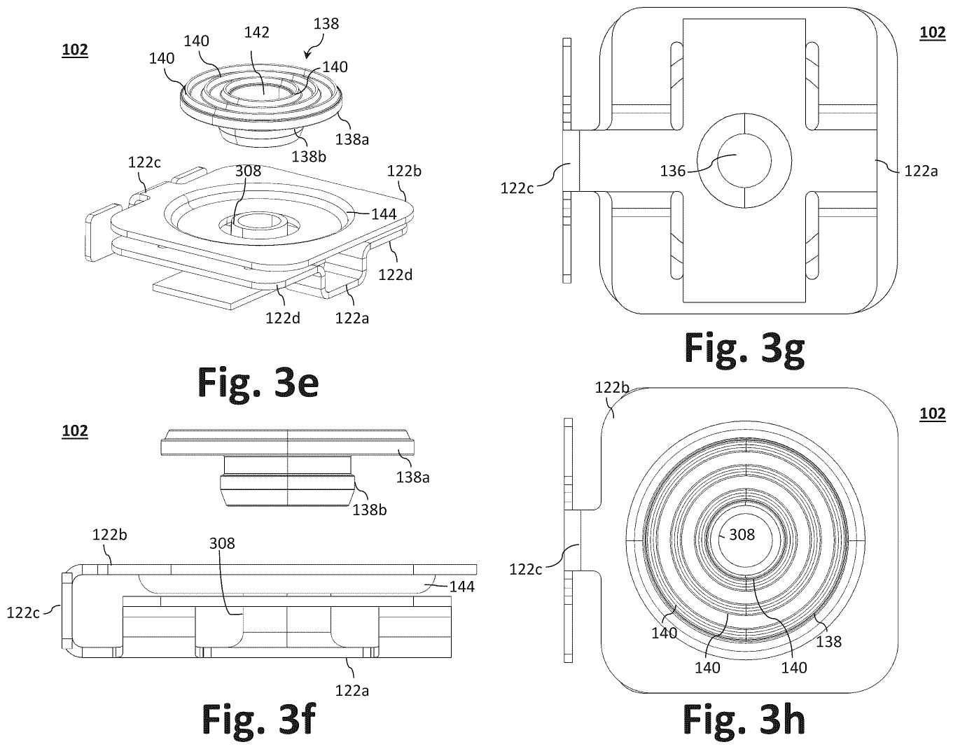

FIG. 3a illustrates a side elevational assembly view of the fastening system 100 in accordance with a third aspect of this disclosure. FIG. 3b illustrates an isometric assembly view of the fastening system 100 of FIG. 3a, with the first component 104 and second component 106 omitted for illustrative purposes, while FIG. 3c illustrates an isometric assembled view thereof. FIG. 3d illustrates a cross-sectional elevation side view of the fastening system 100 of FIG. 3a, taken along cutline C-C (FIG. 3c). FIG. 3e illustrates an isometric assembly view of the sealed fastener assembly 102. FIG. 3f illustrates a side elevational assembly view of the sealed fastener assembly 102. FIG. 3g illustrates a topside assembled view of the sealed fastener assembly 102. FIG. 3h illustrates an underside assembled view of the sealed fastener assembly 102.

The sealed fastener assembly 102 depicted in FIGS. 3a through 3h is similar to the assembly shown in FIGS. 1a through 1h and FIGS. 2a through 2h, with a few differences. To avoid redundancy, features and components already described with reference to the previous example are not repeated here. Instead, the focus is on the new or modified aspects.

In this example, the first component 104 is depicted with an opening 114 formed therein, while the second component 106 features a doghouse structure 302 formed therein or thereon. The doghouse structure 302 defines a slot 304 with one or more engagement features 306. This structure allows the first component 104 to be compatible with a variety of fasteners, including the sealed fastener assembly 102. The opening 114 and/or the doghouse structure 302 can be incorporated into the first component 104 and/or the second component 106 during the manufacturing process or added post-manufacture using mechanical processes (e.g., drilling, cutting, carving), adhesives, or other methods.

The necessity for a separate female fastener 112 is obviated by incorporating a collar 308 into the retainer 110 that includes an internally-threaded bore 132. In this example, the collar 308 is integrated into the first plate 122a and extends toward the second plate 122b, effectively replacing the recessed fastener pocket 126. As illustrated in FIG. 1a, the collar 308 is designed to receive and engage the threaded portion 108d of the shank 108b. Additionally, as shown in FIG. 3d, the collar 308 functions as a compression limiter. The collar 308 is sized such that its height (i.e., represented as third distance (D3)) is substantially equal to the combined thickness of the engagement features 306 and the base of the recessed seal pocket 144 (i.e., the material thickness of the recessed seal pocket 144). The collar 308 is configured to partially enter the opening 114.

In this example, the seal 138 comprises an annular portion 138a and a collar portion 138b that extend perpendicularly from the annular portion 138a. One or more annular rings 140 are formed on one side of the seal 138 (e.g., the side facing the first component 104), while the collar portion 138b is positioned on the opposite side of the seal 138. The annular portion 138a and the collar portion 138b are formed as a unitary structure. The collar 308 is configured to partially enter the opening 114, creating an annular gap 310 between the collar 308 and the opening 114. As illustrated in FIG. 3d, the collar 308 extends through the annular gap 310, forming a seal between the collar 308 and the opening 114.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

1. A sealed fastener assembly for attaching a first component to a second component via a male fastener having a head and a shank, the sealed fastener assembly comprising:
a seal having a generally planar surface and a seal opening; and
a retainer clip having a body portion comprising a first plate that is resiliently connected to a second plate via a clip sidewall to define a channel,
wherein the second plate comprises a recessed seal pocket configured to receive at least a portion of the seal, and
wherein the retainer clip is configured to receive at least a portion of the first component via the channel.

2. The sealed fastener assembly of claim 1, wherein the first plate comprises a recessed fastener pocket with a first opening formed therein.

3. The sealed fastener assembly of claim 2, wherein the recessed fastener pocket is configured to receive the head of the male fastener and to mitigate rotation of the head.

4. The sealed fastener assembly of claim 2, wherein the recessed seal pocket defines a second opening that aligns with the first opening to define a fastener hole configured to receive at least a portion of the shank.

5. The sealed fastener assembly of claim 2, wherein the recessed fastener pocket and the recessed seal pocket are configured to interact with each other to maintain a distance between the first plate and the second plate.

6. The sealed fastener assembly of claim 2, wherein the recessed seal pocket is configured to extend from the second plate toward the first plate.

7. The sealed fastener assembly of claim 2, wherein the recessed seal pocket defines a circular perimeter.

8. The sealed fastener assembly of claim 1, wherein the generally planar surface of the seal comprises one or more annular rings are configured to compress or deform during assembly.

9. The sealed fastener assembly of claim 8, wherein the seal opening is concentric with the one or more annular rings.

10. The sealed fastener assembly of claim 1, wherein the seal defines a second generally planar surface that is opposed to the generally planar surface.

11. The sealed fastener assembly of claim 10, wherein the second generally planar surface comprises one or more annular rings.

12. The sealed fastener assembly of claim 1, wherein the seal defines an annular portion that defines the generally planar surface and a collar portion that extends perpendicularly from the annular portion.

13. The sealed fastener assembly of claim 1, wherein the first plate defines a set of planar wings that is generally parallel to the first plate and offset relative to the first plate by a distance.

14. The sealed fastener assembly of claim 1, wherein the first plate comprises a collar having an internally-threaded bore configured to threadedly engage the shank.

15. The sealed fastener assembly of claim 1, wherein the retainer clip is a stamped-metal component.

16. The sealed fastener assembly of claim 1, wherein at least one of the first plate or the second plate defines one or more retainer tabs configured to retain the male fastener as a part-in-assembly (PIA).

17. A retainer clip for attaching a first component to a second component via a male fastener having a head and a shank, the retainer clip comprising:
a first plate having a recessed fastener pocket with a first opening formed therein,
wherein the recessed fastener pocket is configured to receive the head of the male fastener and to mitigate rotation of the head; and
a second plate having a recessed seal pocket with a second opening formed therein,
wherein the second plate is resiliently connected to the first plate via a clip sidewall to define a channel,
wherein the recessed seal pocket is configured to receive at least a portion of a seal,
wherein the retainer clip is configured to receive at least a portion of the first component via the channel, and
wherein the recessed fastener pocket and the recessed seal pocket are configured to interact with each other to maintain a distance between the first plate and the second plate.

18. The retainer clip of claim 17, wherein at least one of the first plate or the second plate defines one or more retainer tabs configured to retain the male fastener as a part-in-assembly (PIA).

19. A retainer clip for attaching a first component to a second component via a male fastener having a head and a shank, the retainer clip comprising:
a first plate having a collar with an internally-threaded bore configured to threadedly engage the shank; and
a second plate having a recessed seal pocket with a second opening formed therein,
wherein the second plate is resiliently connected to the first plate via a clip sidewall to define a channel,
wherein the recessed seal pocket is configured to receive at least a portion of a seal,
wherein the retainer clip is configured to receive at least a portion of the first component via the channel.

20. The retainer clip of claim 19, wherein the collar is configured to maintain a distance between the first plate and the second plate.
